(19) United States
(12) Patent Application Publication
(10) Pub. No.: US 2010/0319701 A1
(43) Pub. Date: Dec. 23, 2010

(54) MASK SECURING DEVICE

(75) Inventor: David Andrew Connell, Bath (GB)

Correspondence Address: MCGARRY BAIR PC, 32 Market Ave. SW, SUITE 500, GRAND RAPIDS, MI, 49503, US

(73) Assignee: AVON POLYMER PRODUCTS LIMITED, Melksham (GB)

(21) Appl. No.: 12/818,383

(22) Filed: Jun. 18, 2010

(30) Foreign Application Priority Data
Jun. 18, 2009 (GB) 0910582.6

(51) Int. Cl. A62B 18/08

(52) U.S. Cl. 128/207.11

(57) ABSTRACT

A respirator assembly has a respirator mask and a separate bracing device. The bracing device has a pressure element mountable over a frontpiece of the respirator mask, which bears against that frontpiece to hold the respirator mask against the face of a user. The bracing device also has two connection portions, each having one end attached to the pressure element and the other end being for attaching the bracing device to a helmet worn by the user. The connection portions are extendable. Thus, shortening or distending the connection portions reduces the distance between the helmet and the respirator mask and thereby causes the pressure element to bear against the frontpiece of the respirator mask, compressing the user's head between the helmet and the mask and thereby holding the mask against the user's face.

### CROSS-REFERENCE TO RELATED APPLICATION

This application claims the benefit of GB0910582.6, filed Jun. 19, 2009, which is incorporated herein by reference in its entirety.

### BACKGROUND OF THE INVENTION

1. Field of the Invention

This invention relates to a device for securing a mask to the face of a user, more particularly to a device for use where the user is wearing headgear.

2. Summary of the Prior Art

Many types of mask are known, including the respirator (or ‘gas’) mask. Such masks are primarily used in extreme situations, such as warzones, police operations and fires. They serve to protect the user from inhalation of harmful substances such as smoke or chemical and biological agents. So, it is vitally important that the mask can be donned quickly and easily by the user, to limit any possible exposure. Respirator masks employ filtration systems to purify air before it is inhaled by the user, and a tight seal between the mask and the face of the user is of great importance.

One example of a respirator mask 170 is shown in FIG. 17. Masks generally comprise a facepiece 171 of, for example, rubber or stiffened rubber. To this may be attached a front module 172. This front module 172 is often formed as a separate component of, for example, plastics material, and can include features to improve user comfort such as a dedicated exhale vent 173 and a drinks tube 174 and coupler 175. A visor 176 may also be attached to the facepiece 171, again often being formed as a separate part, to protect the user's eyes from harmful substances.

Masks may be formed with one or more integral filters, or with separable, changeable filter modules. In the example shown, the facepiece 171 has filter mounts 177 attached, each of which can receive a filter module (not shown) to protect the user's air supply from contamination.

To don the mask 170, generally a harness (not shown) is attached and worm by the user. The harness is attached to the mask facepiece 171 at various strap fixment points 178.

The illustrated mask 170 extends to fit against the user's forehead. So, a forehead portion 179 of the mask may be defined, broadly, as the part of the mask 170 which sits against the user's forehead. The rim 180 of the mask, substantially its whole periphery, is generally designed to form a tight reflex seal to the user, substantially sealing a part of the user's face behind the mask 170. Wearing the illustrated mask 170, the user's mouth, nose and eyes will all be sealed from outside conditions.

A “frontpiece” 181 of the mask 170 can be defined, as that part of the mask 170 design to sit over or around the user's mouth and nose. This general region 181 is illustrated in FIG. 17 by light shading of the mask 170. Of course, it will be understood that this general region 181 does not have precisely defined boundaries. In practice, the frontpiece generally comprises the front module 172 and the material of the facepiece 171 immediately adjacent or surrounding the front module 172. More specifically, the frontpiece may comprise the exhale vent 173 of the mask 170, and the immediately surrounding material.

In situations where a respirator may be necessary, protective headgear is often also necessary. For example, both police and military forces often wear helmets throughout an operation, with a respirator mask being donned as required. So, masks must be designed to be easily donned even when the user is wearing such headgear.

One solution is to form fitment points on the helmet, with corresponding fitments on the mask. An example of such an arrangement is shown in US 2007/0157439. In this arrangement, a mask is formed with two connection arms extending from the edge of the mask, which can be hooked onto the helmet. By shortening the arms via adjustment pieces, the mask is pressed to the face of the helmet wearer.

Similar attachment arrangements are shown in DE 196 25 337, AU 2008202095 and U.S. Pat. No. 5,555,569. Each of these documents shows a system of fitments formed on the mask, which can be variously clipped or latched onto corresponding parts of the appropriate helmet.

### SUMMARY OF THE INVENTION

There are numerous disadvantages to such systems. Primary amongst these is that the mask arms may be unnecessary in certain situations. If, for example the user is not wearing the helmet, the mask is either unusable or, if used, interferes with the user's comfort due to movement of the unattached arms. So, the mask can only be used at times where the correct helmet is worn by the user, and when the particular mask is appropriate. This means that, for maximum safety of the users, a variety of masks must be provided for each circumstance. This is not only excessively costly, but may unduly burden the user with extra equipment, only some of which is ever in use. Additionally, the pressure keeping the mask to the user's face is transferred by the connecting arms at the edges of the mask, which leads to pressure being put on the body of the mask. Such lateral pressure can deform the mask and inhibit its function, or even compromise the integrity of the seal provided by the mask.

Accordingly, there is provided in a first aspect of the present invention a respirator assembly to bear against the face of a user wearing a helmet, comprising: a respirator mask having a frontpiece; and a bracing device, comprising: a pressure element mounted over the frontpiece of the respirator mask, for bearing against the frontpiece of the respirator mask to hold the respirator mask against the face of a user; and two connection portions, each having a first end attached to the pressure element and a second end opposite the first end for attaching the bracing device to a helmet worn by a user, the connection portions being extendable; the bracing device being separable from the respirator mask.

In such an assembly, when the connection portions are attached to a helmet worn by a user and the pressure element is mounted over the frontpiece of the respirator mask, shortening or distending the connection portions reduces the distance between the helmet and the respirator mask and thereby causes the pressure element to bear against the frontpiece of the respirator mask, compressing the user's head between the helmet and the mask and thereby holding the mask against the face of the user. The connection portions may be pre-extended to allow fitment to a helmet, and thereby facilitating the distension. Deformation of the mask is limited by both the spread of load across the mask and the pressure element itself, which reduces deflection of the mask material.

This arrangement allows a user to quickly don the respirator mask, using the bracing device to secure it in position. Furthermore, the separability of the bracing device from the respirator mask means that the bracing device can be carried separately. Alternatively, the bracing device can be used as a cradle, attached to the user via a neckstrap, for carrying the respirator mask. This lessens any awkwardness which might be caused by connection arms etc. which are permanently attached to the helmet. The mask is still functional without the helmet and vice versa, and in such circumstances only the device of the present invention need be carried, as opposed to a second mask. Additionally, the bracing device may be used with a variety of masks.

References to the “frontpiece” of the respirator mask are intended to generally describe the part of the respirator mask designed to sit on, over or around the mouth and nose of the user. The frontpiece is not necessarily a separate part of the mask, but is generally formed integrally with the rest of the mask. Generally, this frontpiece includes the front module of the mask, which itself generally includes an exhale valve.

Respirator masks of the type used in the present invention often further comprises a visor, goggle or other eye protecting portion, generally formed integrally with the rest of the mask, to protect the user's eyes from caustic or otherwise damaging substances. This portion is generally transparent, translucent or otherwise allows the user to see through it.

In most embodiments, the bracing device is not and does not become attached to the respirator mask. Although the bracing device bears against the respirator mask, and may be adapted for this purpose, it is not generally physically bonded to the mask. By forming a non-bonded connection to the respirator mask, there is no time delay on removal of the device caused by a need to “detach” the bracing device or “disassemble” part of the assembly. Similarly, no delay in putting the mask on is caused by a need to assemble and attach the bracing device to the mask.

In many embodiments, the first ends of the connection portions are attached to the pressure element at positions proximal the frontpiece of the mask. So, pressure is spread evenly across the frontpiece of the mask, transferring through the mask's structure and manifesting on the reflex seal against the face. This is much more comfortable for the user because load is spread to the mask as opposed to onto the user's face, and does not place strain directly onto the mask or the bracing device itself, spreading the excess load across the full surface of the mask. This spread through the mask reduces the chance of deformation or failure of the structure.

When the frontpiece has a front module having an exhale valve or vent, it is advantageous for the pressure element of the bracing device to have an aperture or other formation therein through which the exhale valve can protrude. This allows the bracing device to hold the mask against the user's face without interfering in the use of the functions of the mask. Blocking the exhalation valve without providing an alternative airway would be highly disadvantageous to the user.

For example, in some embodiments the bracing device may have branches extending to fit on both sides of the exhale vent. Such an arrangement allows pressure to be applied evenly to the front of the mask, and evenly around the frontpiece.

In some embodiments, to bear against the face of a user wearing a helmet with a visor, the pressure element of the bracing device is adapted to overlap the exhale valve of the respirator mask such that air exhaled through the exhale valve is channelled away from the visor of the helmet.

When a helmet with a protective visor is worn, the visor is usually of sufficient length to completely protect the user's face, and therefore the bracing device is generally covered. In these situations, the exhale valve of the respirator mask being worn is very close to the visor. When the user exhales through the valve, the warmth and moisture of the exhaled air may be sufficient to cause condensation to form on the visor, leading to a ‘fogging’ effect. This can seriously impair visibility and the user's safety.

So, if the pressure element is adapted such that it partially obscures the exhale valve of the respirator mask, it can act to divert or funnel exhaled air downwards or otherwise away from the deployed visor. This can greatly reduce the fogging effect.

To direct the air in a generally downward direction, the bracing device can overlap the exhale valve by having an enlarged piece running over the upper part of the frontpiece, in the area of the user's nose. By extending this piece, particularly to the point of overhanging the exhale valve aperture in the bracing device, or to close or cover a part of that aperture, air exhaled is prevented from contacting the visor by the overlapping part of the bracing device, and diverted away.

When a helmet with a visor over the user's face is worn by the user, such a bracing device can divert exhaled air away from that visor.

The present invention therefore also provides a respirator helmet, comprising a helmet with a visor that fits over the user's face, a respirator mask having a frontpiece with an exhale valve therein, and a bracing device as discussed above which is adapted to divert exhaled air from the exhale valve away from the visor of the mask.

The present invention also provides a bracing device which is so adapted.

Some helmets may feature a retractable, removable or otherwise adjustable visor. Bracing devices adapted to channel exhaled air are adapted to channel away from the visor when that visor is in a deployed, mounted etc. position over the user's face.

In most embodiments, at least one of the connection portions is formed in at least two pieces: a first piece comprising the first end of the connection portion and being attached to the pressure element; a second piece comprising the second end of the connection portion and being for attaching the bracing device to a helmet worn by the user; the second piece being connected to the first piece such that it is movable with respect thereto, thereby extending or distending the connection portion. By segmenting the connection portions and coupling the resulting pieces, a greater level of comfort can be achieved for the user as the connection portions can more easily distort to fit the individual user's face. By providing an adjustable length, a wide variety of fits can be achieved. Furthermore, such segmenting allows for much greater articulation in the connection pieces, again improving the user's comfort and the range of fits possible. Such articulation also allows the user more freedom of movement for the user when wearing the mask, which is advantageous if they are in a situation in which they must, for example, speak or shout.

Preferably, the connection between the second piece and the first piece is elastic in behaviour. This allows for the above described articulation, comfort and improved fit, while making sure that the integrity of the fitment of the mask is not affected. With an elasticated coupling, the mask is pulled back into position, for example after the user's movement ceases. References herein to “elastic” and “elasticated” should be taken as references to the mechanical behaviour of the portions mentioned, as opposed to as definitions of a particular material for those portions.

In some embodiments, the first piece is connected to the second piece by a strap, the strap being anchored at anchor point on one of the first or the second piece; the other of the first and second piece having a pawl projection thereon, and being adapted to define a path past the pawl projection through which the strap can run such that the pawl projection can engage a strap in the path to limit movement of that strap through the path, the pawl projection being movable from a first position in which it can engage a strap in the path to a second position in which it cannot engage a strap in the path.

The pawl and strap configuration in these embodiments generally acts to allow motion of the strap in one direction (for example, to tighten the connection between the first and second pieces of the connection portion and thereby the fit on the user) while prohibiting motion in the opposite direction (thus reducing the chance of the mask working loose). The pawl acts as a simple brake to inhibit movement of the strap in one direction.

In some such embodiments, the piece having the pawl projection comprises a lever pivotable around a fixed fulcrum mounted on that piece; the portion of the lever on one side of the fulcrum comprising the pawl projection; the lever having a first position in which the pawl projection can engage a strap in the path and a second position in which the pawl projection cannot engage a strap in the path.

This type of lever enables the user to quickly and easily engage or disengage the pawl, meaning that motion of the strap can be prevented when required (for example, when the device is in use) and then quickly permitted (for example, to allow quick doffing of the device). By pivoting around a fulcrum, one half of the lever can serve as a release button, which allows the user to easily control the position of the pawl even while wearing bulky protective equipment.

Generally, the lever is biased toward the first position. This means that the ‘default’ position is for movement of the strap to be prohibited.

In such embodiments, the lever may be biased by a resilient cantilever member mounted on the piece comprising the lever such that the cantilever member is deflected from its rest position when the lever is in the second position. Such a member acts as a very simple spring, to return the pawl to its rest position after it has been deflected by the user. The cantilever member has the additional advantage that it is very simple, and can be positioned such that it protects the more intricate pawl member from outside interference. Of course, other biasing methods such as use of an elastic member are also suitable.

In the above described embodiments, the path may be substantially U shaped, running from an anchor point on one of the first and second piece to the other of the first and second piece, past the pawl projection on that piece, and through the piece which comprises the anchor point. The mean that, when a strap is fed through the path, the user can tighten the fit of the mask (i.e. move the strap in the direction allowed by the pawl) by pulling the straps around the ‘loop’ of the U shaped path. This force acts to pull the first and second pieces together, meaning that tightening can be achieved by moving only the straps. If the path is straight, one piece must be held in place while the other is pulled by way of the strap.

In many embodiments, the strap is anchored to the first piece, the second piece having the pawl projection thereon.

One preferred method of engagement between the pawl and the strap involves the strap being toothed and the pawl projection being adapted to interlock with said teeth. This forms a ratchet like connection between the two. The components are easily made, and the mechanical interface is relative durable. Alternatives, such as a purely frictional engagement with a gripping pawl and a smooth strap, are also possible.

In some embodiments, one of the first piece and the second piece has a groove therein and the other of the first piece and the second piece comprises a tongue corresponding to the channel, the tongue being mountable in the channel so as to be slideable therein. This type of connection substantially limits extension of the connection portion to a single direction, preventing excess strain developing in the connection portions.

In such embodiments, the first piece and the second piece may be connected by an elastic connection portion secured to the first piece at a first point positioned substantially at one side of the tongue, and connected to the second piece at a second point positioned substantially at the base of the groove. This type of offset or non-parallel connection means that the two pieces of the connection portion are pulled together with forces constantly acting in several dimensions. This reduces the chance of unwanted misalignment of the pieces of the connection portion.

In preferred embodiments, the elastic connection portion is a spring.

In more preferred embodiments, the end of the tongue has a notch therein, and the end of the groove has an overhanging projection thereon corresponding to the notch, such that when the tongue reaches the end of the groove the projection is positioned in the notch. This arrangement means that the tongue is held within the groove, further preventing misalignment of the connection portion pieces and stopping the tongue slipping or being forced out of the groove.

In many such embodiments, the first piece comprises the groove and the second piece comprises the tongue.

In another set of preferred embodiments, one of the first piece and the second piece has an adjustment slot therein, and the other of the first piece and the second piece comprises an adjustment arm, the adjustment arm being adapted to fit into the adjustment slot so as to be slideable therethrough. The arm is constrained by the slot, having a fixed path to prevent unwanted slippage or misalignment.

Preferably, the connection portion further comprises a strap and one of the first piece and the second piece has a strap gripping portion mounted thereon, the strap being attached to the other of the first piece and the second piece and being held by the strap gripping portion. Such a strap allows easy adjustment of the position of the arm through the slot, controlling the first and second pieces of the connection portion. In preferable embodiments, the strap gripping portion is a buckle, more preferably a ladder lock buckle. Buckle give a secure fastening combined with simple unfastening. This is especially true of ladder lock buckles, which can frictionally lock a strap in place until it is tightened.

Alternatively, the strap gripping portion may be a pawl, which inhibits motion of the strap in one direction which allowing motion in another direction. The strap may, for example, be toothed, the pawl comprising a projection to mate with those teeth to provide a ratchet like strap gripping interaction.

The strap gripping portion may hinge with respect to the piece on which it is mounted. This allows a ‘quick-release’ of the strap to be simply achieved by hinging the strap gripping portion appropriately. In the case of a buckle, this may be simply lifting the buckle against the hinge. If the strap gripping portion is a pawl, it may be formed as part of a hinged lever, whereby pressing one side of the lever disengages the pawl from the strap.

Preferably, the strap is sized so as to fit through the adjustment slot, so that it is stowed in a position where it does not interfere with the user and yet can be quickly grasped when needed.

In some embodiments, the strap is at least partially elasticated to give improved comfort and fit.

The piece having the adjustment slot therein may have a guide channel therein along which the adjustment arm can slide, the channel defining a path through the adjustment slot along which the adjustment arm can slide. This channel further serves to restrict the path of the arm, allowing an extending action of the connection piece while restraining any angled, twisted or otherwise misaligned motion.

In many such embodiments, the first piece has the adjustment slot therein and the second piece comprises the adjustment arm.

In some embodiments, the connection portions comprise flexible straps. This type of strap provides a connection between the mask and headgear which still allows independent movement of the two. This is useful for a more comfortable fit, as well as in situation where the user must speak frequently—movement of the jaw otherwise being greatly inhibited by rigidity of the connection between the mask and the helmet.

In some such embodiments, at least one of the connection portions is formed in two pieces, the first piece comprising the first end of the connection portion and being attached to the pressure element and comprising a flexible strap portion, the second piece comprising the second end of the connection portion and being for attaching the bracing device to the helmet of the user and comprising a buckle, a flexible part of the first piece being threaded through the buckle so as to hold the first and second pieces together, wherein increasing the amount of the first piece which is threaded through the buckle reduces the length of the connection portion.

A preferable type of buckle is the ‘ladder-lock’ buckle, which generally has at least two apertures therein, the strap being threaded through one in a first direction and then through the other in a direction opposite the first direction. This effectively forms a ‘loop’ around the material separating the two apertures. In this manner, pulling the strap through the buckle shortens the length of the connection portion between the bracing device and the helmet, but additionally the friction between the strap, the apertures and the buckle is sufficient to hold the strap in its tightened position. Thus, a very quick and simple way of tightening the strap is provided, which does not require any particularly intricate action and so is suited to situations where gloves are worn.

Generally, in all embodiments, the second end of each connection portion comprises a helmet mounting portion, the helmet mounting portion having a hook projection for fitment into a corresponding attachment slot in a helmet worn by a user. This arrangement means that the device can be securely attached on the headgear. Also, reduction of the length, or distension, of the connection portion (and hence increase of the pressure between the mask and the helmet) serves the additional purpose of increasing the strength of connection between the device and the headgear. This is because, as the pressure on the attachment increases, the hook projection is forced more and more firmly into the attachment slot.

In embodiments which comprise flexible straps, it is more generally advantageous that the second end of the connection piece which is formed in two pieces comprises a helmet mounting portion, the helmet mounting portion having a hook projection for fitment into a corresponding attachment slot in a helmet worn by a user and the part of the first piece of the connection portion which is threaded through the buckle being adapted to be secured to the helmet mounting portion. This arrangement allows excess strap to be held out of the user's line of sight, and in a manner that it will not interfere with their activities. The helmet mounting portion may be adapted to receive the first piece of the connection portion, or a further part attached to that piece.

In preferred arrangements of this type, the helmet mounting portion comprises a channel with a slot thereinto; the part of the first piece of the connection piece which is threaded through the buckle having a securing tag thereon, which tag is of a size such that it cannot be passed through the channel of the helmet mounting portion; the first piece being securable to the helmet mounting portion by feeding the first piece of the connection portion through the slot in the channel, the securing tag preventing slippage of the first piece through the channel.

In this arrangement, once the connection portion has been pulled tight through the buckle, the first piece thereof can be pressed through the slot and into the channel in the helmet mounting portion. Should pressure be applied along the length of this piece of the strap, it will not come loose as the securing tag cannot fit through the channel in the helmet mounting portion. However, in situations where release of the strap is desired, the user can simply manoeuvre the flexible strap between the flanges, which action is not inhibited by the size of the securing tag. This construction ensures that the excess strap does not accidentally come out of the headgear mounting portion, and allows the user to be sure that the connection portion and thus the mask itself will only come loose at a desired time.

In all embodiments, the connection portions are preferably attached to the pressure element at substantially diametrically opposite positions. Of course, there is a certain amount of variance possible in the angle between the attachments of the connection portions to the pressure element—the attachments of the connection portions to the pressure element are advantageously spaced apart from one another, to increase the spread of pressure and thus improve the fit of the mask to the face of a user. The spacing apart of the attachments of the connection portions to the pressure element more evenly spreads the pressure over the mask mounting portion of the device.

Preferably, one or both of the connection portions are elasticated. This allows some amount of ‘give’ in the connection portion, even when it is fixed in place holding the mask to the user's face and headgear. Again, this improves the independence of movement of the mask and the headgear, and gives a softer feeling fit to the user's face. Furthermore, the elastication can compensate for any small accidental slippage in the headgear or in the fastening of the device to the headgear.

The respirator mask for use with the bracing devices discussed above may further comprise a forehead portion for fitment against a user's forehead. If so, the bracing device may further comprise a support member attached to each connection portion and extending between the connection portions, for bearing against the forehead portion of the respirator mask to hold that portion against the forehead of a user. The forehead portion may be, for example, the upper ‘rim’ of a visor or goggle part of the respirator mask, or a part of the mask directly above that rim. It is generally any part of the respirator mask designed to be fitted against the user's forehead. Securing a tight fit at the forehead increases the user's safety by further limiting the pathway to, for example, the user's skin and, where a goggle or visor is provided, eyes. By providing a support member between the connection portions, a ‘frame’ is produced which can press against the forehead of the user and provide an improved seal in that area.

A second aspect of the present invention provides a mask bracing device for bearing against a respirator mask with a frontpiece worn by a user wearing a helmet, comprising: a pressure element mountable over the frontpiece of a respirator mask, for bearing against the frontpiece of the respirator mask to hold the respirator mask against the face of a user; and two flexible strap connection portions, each being formed in two pieces, the first piece comprising: a first end of the connection portion attached to the pressure element; and a flexible strap portion; the second piece comprising: a second end of the connection portion for attaching the bracing device to a helmet worn by a user; and a buckle; a flexible strap portion of the first piece being threaded through the buckle so as to hold the first and second pieces together and having a securing tag thereon, wherein increasing the amount of the first piece which is threaded through the buckle reduces the length of the connection portion the second piece comprising a helmet mounting portion, the helmet mounting portion having a hook projection for fitment into a corresponding attachment slot in a helmet worn by a user, the helmet mounting portion comprising a channel with a slot thereinto; the securing tag on the flexible strap portion of the first piece being of a size such that it cannot be passed through the channel of the helmet mounting portion; the first piece being securable to the helmet mounting portion by feeding the flexible strap portion of the first piece through the slot in the channel, the securing tag preventing slippage of the first piece through the channel.

A third aspect of the present invention provides a mask bracing device for bearing against a respirator mask with a frontpiece worn by a user wearing a helmet, comprising a pressure element mountable over the frontpiece of a respirator mask, for bearing against the frontpiece of the respirator mask to hold the respirator mask against the face of a user; and two connection portions each having a first end attached to the pressure element and a second end opposite the first end for attaching the bracing device to a helmet worn by a user, each formed in two pieces, the first piece comprising the first end of the connection portion and being attached to the pressure element; and the second piece comprising the second end of the connection portion and being for attaching the bracing device to a helmet worn by the user; wherein one of the first piece and the second piece has a groove therein and the other of the first piece and the second piece comprises a tongue corresponding to the channel, the tongue being mountable in the channel so as to be slideable therein.

A fourth aspect of the present invention provides a mask bracing device for bearing against a respirator mask with a frontpiece worn by a user wearing a helmet, comprising: a pressure element mountable over the frontpiece of a respirator mask, for bearing against the frontpiece of the respirator mask to hold the respirator mask against the face of a user; and two connection portions each having a first end attached to the pressure element and a second end opposite the first end for attaching the bracing device to a helmet worn by a user, each formed in two pieces, the first piece comprising the first end of the connection portion and being attached to the pressure element; and the second piece comprising the second end of the connection portion and being for attaching the bracing device to a helmet worn by the user; one of the first piece and the second piece having an adjustment slot therein, and the other of the first piece and the second piece comprising an adjustment arm, the adjustment arm being adapted to fit into the adjustment slot so as to be slideable therethrough.

A fifth aspect of the present invention provides a mask bracing device for bearing against a respirator mask with a frontpiece worn by a user wearing a helmet, comprising: a pressure element mountable over the frontpiece of a respirator mask, for bearing against the frontpiece of the respirator mask to hold the respirator mask against the face of a user; and two connection portions each having a first end attached to the pressure element and a second end opposite the first end for attaching the bracing device to a helmet worn by a user, each formed in two pieces, the first piece comprising the first end of the connection portion and being attached to the pressure element; and the second piece comprising the second end of the connection portion and being for attaching the bracing device to a helmet worn by the user; the first piece being connected to the second piece by a strap, the strap being anchored at anchor point on one of the first or the second piece; the other of the first and second piece having a pawl projection thereon, and being defining a path past the pawl projection through which the strap runs such that the pawl projection is engageable with the strap to limit movement of that strap through the path, the pawl projection being movable from a first position in which it is engaged with the strap to a second position in which it is disengaged from the strap.

A sixth aspect of the present invention provides a respirator helmet, comprising: a helmet; a respirator mask having a frontpiece; and a bracing device, comprising: a pressure element mounted over the frontpiece of the respirator mask, for bearing against the frontpiece of the respirator mask to hold the respirator mask against the face of a user; and two connection portions, each having a first end attached to the pressure element and a second end opposite the first end attached to the helmet, the length of the connection portions being adjustable; the bracing device being separable from the respirator mask and from the helmet.

A seventh aspect of the present invention provides a kit of parts for constructing a respirator assembly to bear against the face of a user wearing a helmet, comprising: a respirator mask having a frontpiece; and a bracing device, comprising: a pressure element adapted to be mountable over the frontpiece of the respirator mask, for bearing against the frontpiece of the respirator mask to hold the respirator mask against the face of a user; and two connection portions, each having a first end attached to the pressure element and a second end opposite the first end for attaching the bracing device to a helmet worn by a user, the length of the connection portions being adjustable.

An eighth aspect of the present invention provides a kit of parts for constructing a respirator helmet, comprising: a helmet; a respirator mask having a frontpiece; and a bracing device, comprising: a pressure element adapted to be mountable over the frontpiece of the respirator mask, for bearing against the frontpiece of the respirator mask to hold the respirator mask against the face of a user; and two connection portions, each having a first end attached to the pressure element and a second end opposite the first end adapted to be attachable to the helmet, the length of the connection portions being adjustable.

A ninth aspect of the present invention provides a method for fitting a respirator mask with a frontpiece to the face of a user wearing a helmet having attachment slots therein, comprising the steps of: (i) positioning a bracing device as described above over the frontpiece of the respirator mask; (ii) positioning the respirator mask on the face of the user; (iii) attaching the connection portions of the bracing device to the attachment slots of the helmet; and (iv) reducing the length of the connection portions between the mask and the helmet, thereby compressing the user's head between the helmet and the mask to hold the mask to the user's face.

It should be understood that each of the features discussed with respect to the first aspect applies equally to each other aspect of the present invention.

### BRIEF DESCRIPTION OF THE DRAWINGS

Examples embodying the present invention are now described with reference to the accompanying drawings in which:

FIG. 1 is a diagrammatic side view of a first embodiment of the present invention.

FIG. 2 is a diagrammatic side view of a second embodiment of the present invention.

FIG. 3 is an enlarged diagrammatic view of an example headgear mounting portion for use with the present invention.

FIGS. 4 to 8 show the fitment steps of a third embodiment of the present invention.

FIG. 9 shows a front view of the first embodiment of the present invention shown in FIG. 1.

FIG. 10 is a diagrammatic side view of a third embodiment of the present invention, with the respirator mask excluded for clarity.

FIG. 11 is a diagrammatic cross-sectional view of the connection portion of the third embodiment of the present invention shown in FIG. 10.

FIG. 12 is an exploded diagrammatic view of the connection portion of the third embodiment of the present invention shown in FIG. 10.

FIG. 13 is a diagrammatic side view of a fourth embodiment of the present invention, with the respirator mask excluded for clarity.

FIG. 14 is a diagrammatic side view of a fifth embodiment of the present invention, with the respirator mask and helmet excluded for clarity.

FIG. 15 is a diagrammatic cross sectional view of one design of the connection portion of the fifth embodiment of the present invention illustrated in FIG. 14.

FIG. 16 is a detailed cutaway view of one design of the connection portion of the fifth embodiment of the present invention illustrated in FIG. 14.

FIG. 17 is a diagrammatic view of a respirator mask. It is included for ease of understanding references to parts of the mask itself.

For clarity, the user of the device is not shown in any of these figures.

### DETAILED DESCRIPTION

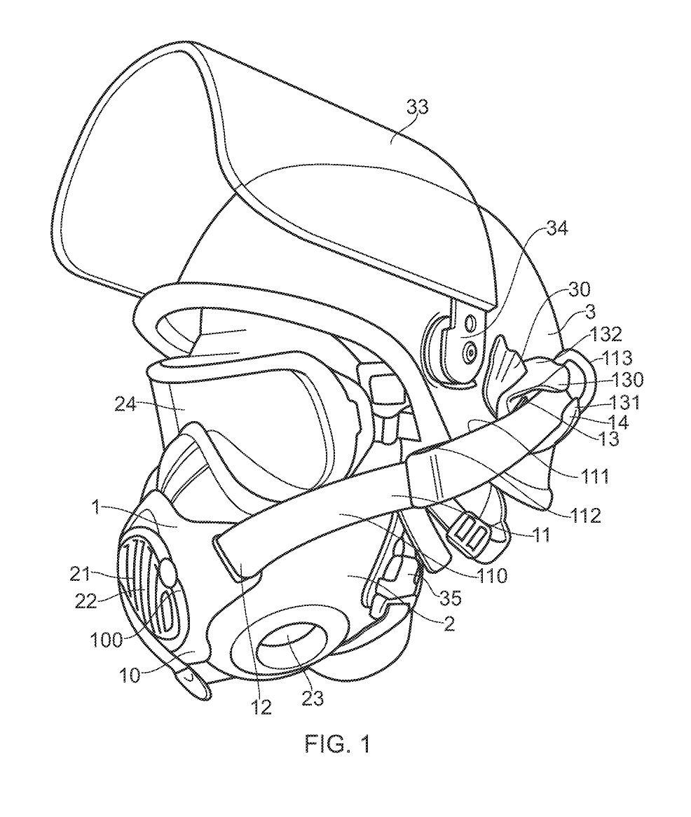

FIG. 1 shows a first embodiment of the present invention. A bracing device 1 is shown fitted to a respirator mask 2 and attached to a helmet 3. The helmet 3 has a visor 33 mounted via hinges 34, and attachment slots 30 (one shown) therein. A series of straps 35 are provided for fine adjustment of the exact fit of the helmet 3. The respirator mask 2 comprises a front module 21, in which exhale valve 22 is formed. The mask covers the face of the user (not shown), to protect from dangerous environments. The mask has fitments 23 for filter modules, and a further protective visor portion 24 for protecting the eyes of the user. Of course, similar bracing devices can be used with other types of mask and headgear.

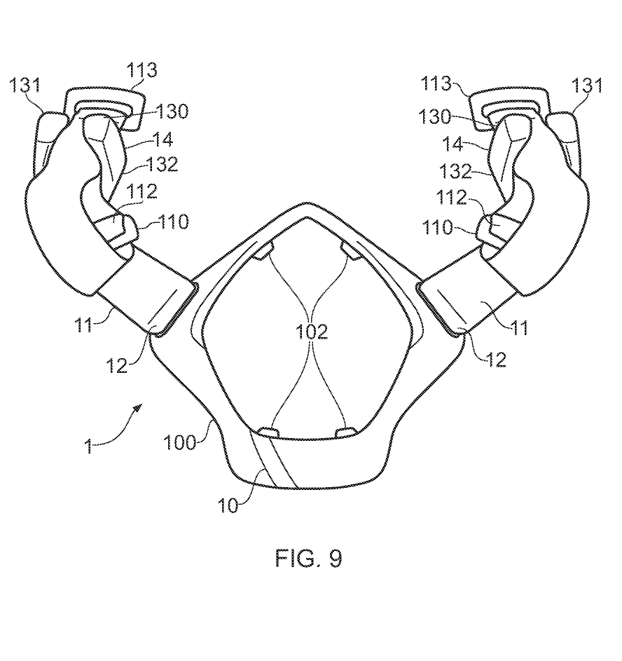

In the illustrated embodiment, the bracing device 1 comprises a pressure element 10, connection portions in the form of flexible straps 11, and helmet mounting portions 14. Note that, although only one strap 11 and helmet mounting portion 14 can be seen in FIG. 1, another pair is provided on the other side of the pressure element 10. This can be seen more clearly in FIG. 9. The connection portions 11 are attached to the pressure element 10 at a first end 12, and to the attachment slots 30 of the helmet 3 at a second end 13.

The illustrated connection portion 11 is divided in two pieces 110, 111. The first piece 110 is attached to the pressure element at a first end 12, and the second piece 111 (partially obscured) is shown attached to the helmet at the second end 13. In the illustrated embodiment, a helmet mounting portion 14 is provided at the second end 13 of the connection portion 11, for attaching the connection portion 11 to the attachment slot 30 in the helmet. The two pieces of the connection portion 11 are joined at a buckle 112, through which part of the first piece 110 of the connection portion 11 is threaded.

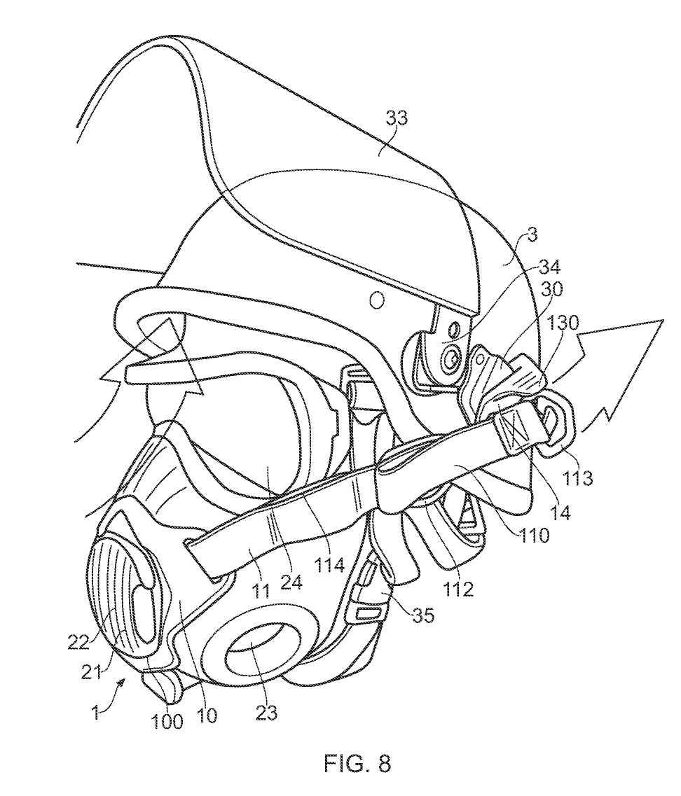

The part of the first piece 110 which is threaded through the buckle 112 can be secured to the helmet mounting portion 14. The helmet mounting portion 14 comprises flanges 130, 131 which combine to form a channel, a slot into the channel being formed by the gap between the flanges 130, 131. The part of the first piece 110 which is threaded through the buckle 112 terminates with a securing tag 113, which is sized so that it cannot be moved through the channel created by the flanges 130, 131 on the helmet mounting portion 14. As shown in FIG. 8, by feeding the part of the first piece 110 which is threaded through the buckle 112 into the slot in the channel of the helmet mounting portion 14, the first piece 110 of the connection portion can be positioned in the channel despite the size of the securing tag 113. The size of the securing tag 113 then prevents the first piece 110 from accidentally slipping out of the helmet mounting portion 14, which would lead to the piece interfering with the user. When such release is desired, for example to remove the mask 2, the user can manipulate the first piece 110 back out of the slot formed by the flanges 130, 131. This complex action is very unlikely to occur accidentally in normal usage.

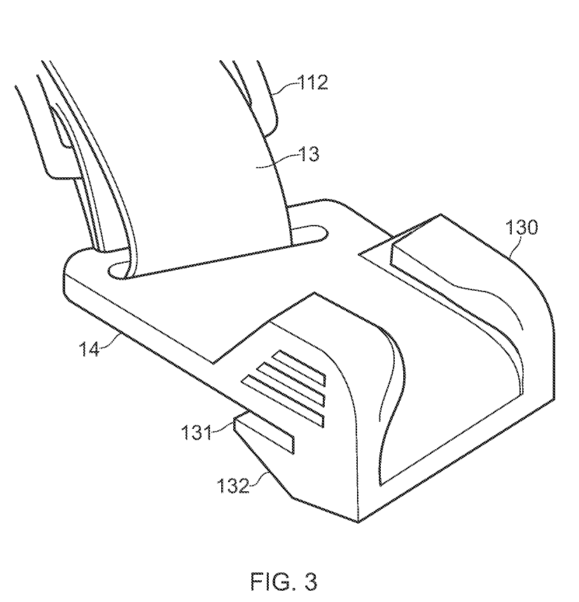

The helmet mounting portion 14 is held on the helmet 3 by a hook projection 132, which fits into the attachment slot 30 in the helmet 3. An example of a helmet mounting portion 13 can be seen more clearly in FIG. 3.

In the illustrated embodiment, the pressure element 10 fits over the front module 21 of the mask 2. To avoid any interference with the function of the mask 2, the mask mounting portion 10 is formed with an aperture 100 therein through which the exhale valve 22 of the mask 2 protrudes. The inner surface of the pressure element 10 may be fitted with lugs 102 (not shown) or other contours to fit more closely to the mask 2 being used, as shown in FIG. 9. In the illustrated embodiment, the connection portions 11 are attached to the pressure element 10 at positions proximal the front module 21. This arrangement provides an optimal pressure distribution to the mask 2, pressing it onto the user's face without putting pressure on the body or form of the mask 2 or the bracing device 1. Additionally, the pressure is applied mainly on the user's cheeks, as opposed to their orbital bones.

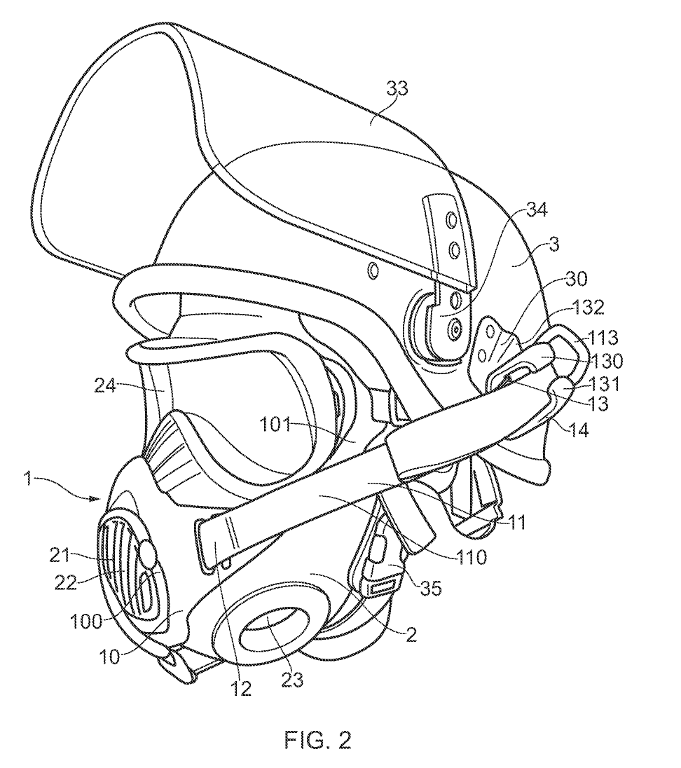

FIG. 2 shows a second embodiment of the present invention. This embodiment is similar to that shown in FIG. 1, except in the shape of the pressure element 10. In this embodiment, the pressure element 10 further comprises arms 101 extending to a position proximal the user's orbital bone. The arms 101 engage the mask 2, providing further distribution of pressure and evening the pressure of the user's face.

FIG. 3 shows a close up of a helmet mounting portion 14 for use in the present invention. This figure more clearly shows the hook projection 132 for fixing the helmet mounting portion 14 to a suitably adapted headgear. The channel formed by the inwardly extending flanges 130, 131 can also be seen.

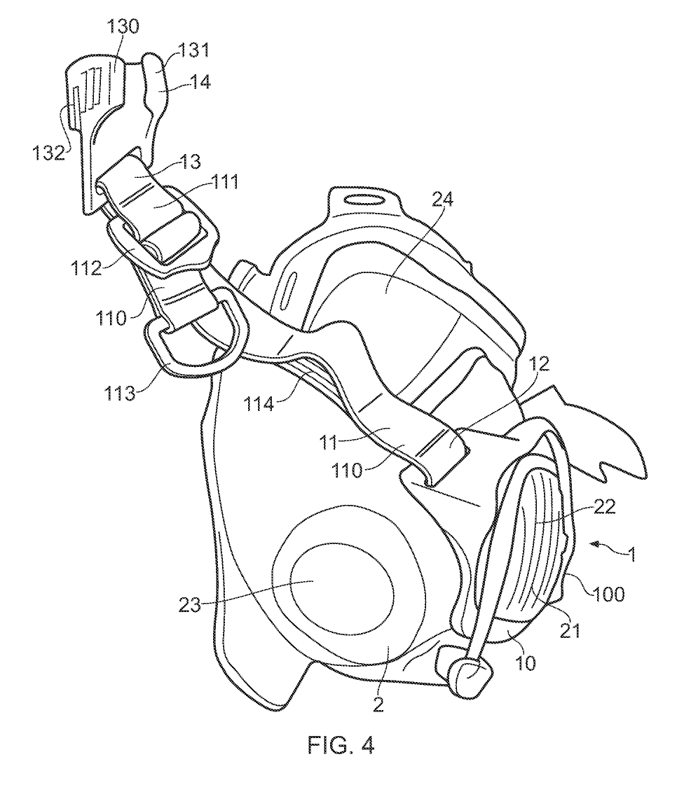

FIGS. 4 to 8 show a series of the steps involved in using a third embodiment of the present invention to hold a mask to a user's face. The connection portions 11 of this embodiment are fitted with an elasticated expansion section 114, which allows for a more comfortable and flexible fit to the user's face. FIG. 4 shows the bracing device 1 fitted over the front module 21 of a mask 2, although the bracing device 1 and the mask 2 are separable.

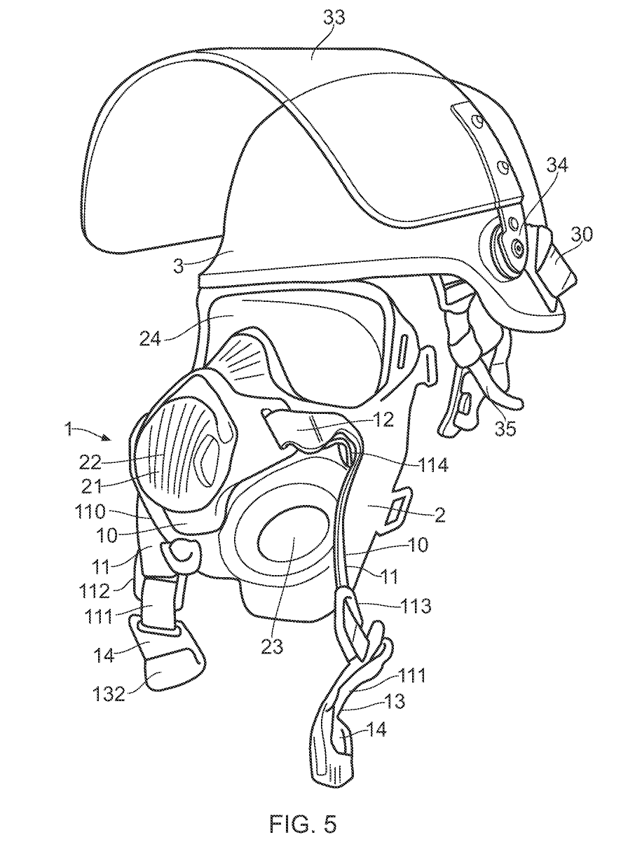

When the bracing device 1 is firmly seated on the mask 2, for example by way of lugs 102 as shown in FIG. 9, the user positions the mask 2 on their face. This is shown in FIG. 5. The mask 2 fits onto the user as normal—with the illustrated arrangement, this means that the mask 2 fits partially under the helmet 3.

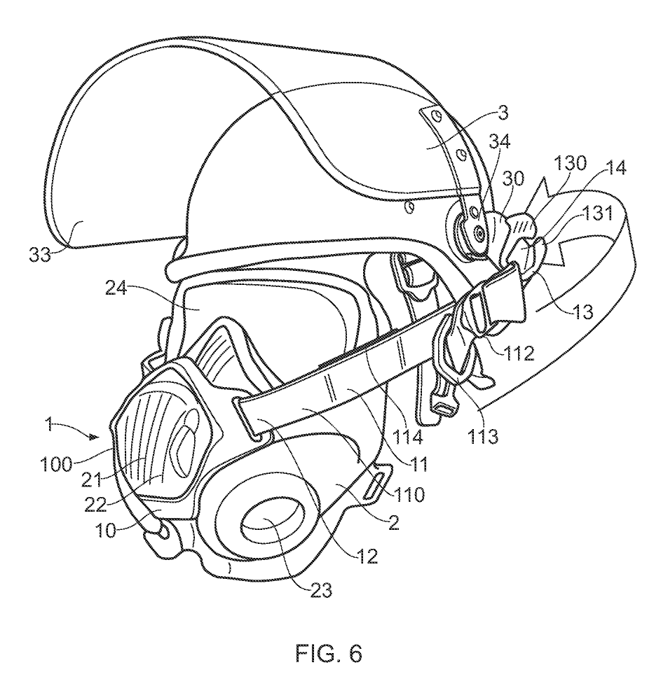

Once the mask 2 is in position, each of the helmet mounting portions 14 is attached to the helmet 3, as shown in FIG. 6, in the illustrated embodiment by way of fitting the hook projection 132 into the attachment slot 30 provided on the helmet 3.

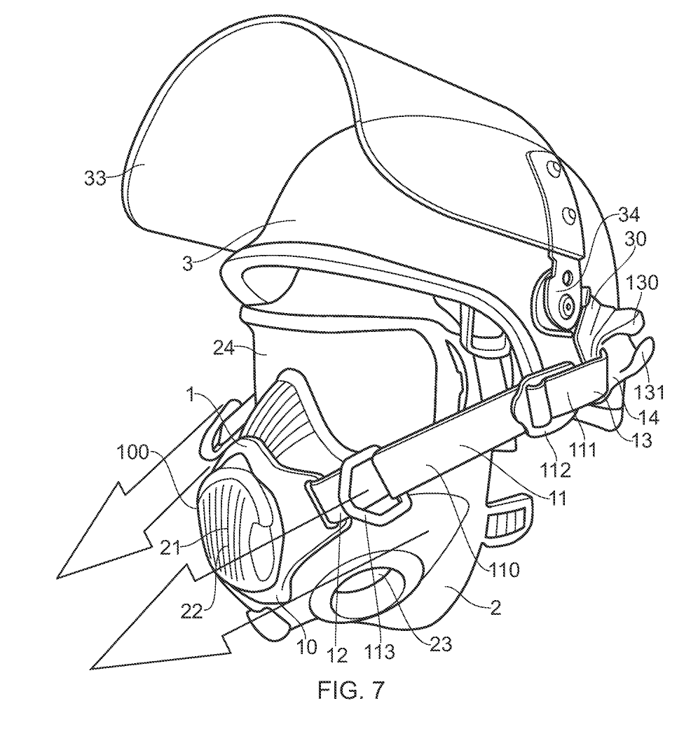

At this point the mask 2 is fitted to the user and attached to the helmet 3, but is most likely not properly tightened to give a secure protective seal. So, the connection portions 11 are reduced in length by increasing the amount of the first piece 110 which is threaded through the buckle 112, by pulling the first pieces 110 towards the front module 10. This action is shown in FIG. 7. This tightening motion reduces the effective length of the connection portions 11, pressing the mask 2 more firmly onto the user's face to provide a secure fit. Additionally, because of the angle of the hook projection 132 and attachment slot 30 used to attach the headgear mounting portion 13 to the helmet 3, this action increases the security of that attachment.

After this action, the mask 2 is properly fitted to the user. However, there may be some length of the first piece 110 of the connection portion 11 left free, and this might interfere with the user's actions or line of sight. So, as shown in FIG. 8, the excess of the first piece 110 can itself be attached to the helmet mounting portion 14. The helmet mounting portion 14 has flanges 130, 131, between which the first piece 110 can be pressed. A security tag 113 at the end of the first piece 110 then holds the first piece 110 in place, as described above with reference to FIG. 1.

FIG. 9 shows a front view of the embodiment of FIG. 1. In this Figure, the lugs 102 on the interior surface of the pressure element 10 can be seen. These lugs 102 help seat the bracing device 1 securely on the mask 2 (not shown) to be used. Two connection portions 11 extend from substantially diametrically opposite sides of the pressure element 10, to provide an even pressure to the mask 2. In FIG. 9, there is again shown the excess of the first piece 110 positioned in the channel in the helmet mounting portions 14, the securing tags 113 preventing withdrawal through the channel.

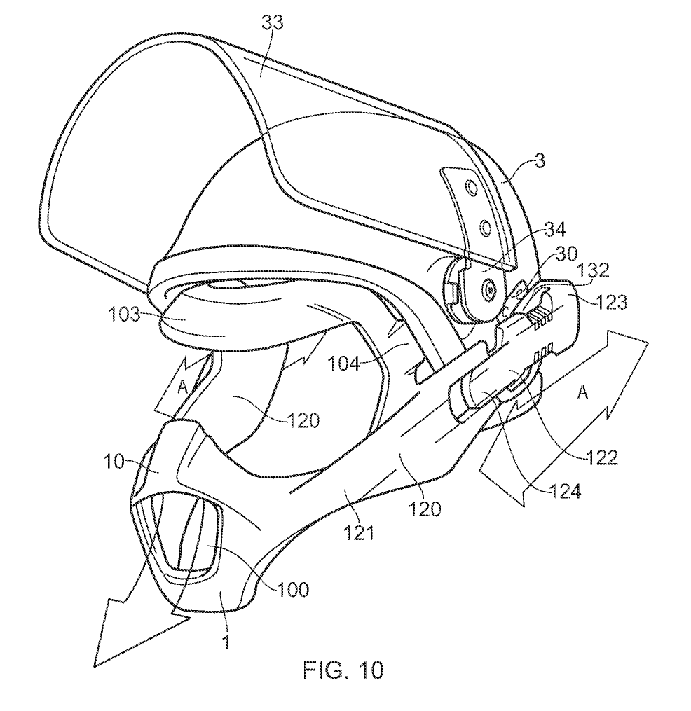

FIG. 10 shows a bracing device 1 according to a third embodiment of the present invention, partway through the process of attachment to a helmet 3. The bracing device 1 comprises a pressure element 10 for bearing against the front module of a respirator mask (not shown) as described above. In this embodiment, the connection portions 120 are formed in two pieces: a first piece 121 connected to the pressure element 10, in this embodiment by integral moulding, and a second piece 122 for attachment to the helmet 3. The second piece comprises a helmet mounting portion 123, which in this embodiment has a hook projection 132 as described above.

The first and second pieces 121, 122 of the connection portions 120 are coupled together so that the second piece 122 is slideable with respect to the first piece 121, as symbolised by the arrows “A” in FIG. 10. This coupling allows the length of the connection portions 120 to be increased or decreased as necessary. Such adjustment by extension or distension of the connection portions 120 allows for a close yet comfortable fit to the user. The connection portion 120 is shown partially extended in FIG. 10.

In the illustrated embodiment, the first piece 121 and second piece 122 are elastically coupled by a spring (not shown). The spring biases the first and second pieces 121, 122 together, so that to fit the bracing device 10 the second piece 122 must be “stretched” away from the first piece 121 to be attached to the helmet 3 via the hook projections 132. Once the second piece 122 is fitted to the helmet 3, the biasing of the spring pulls the first piece 121 and thereby the rest of the bracing device 1 and the mask towards the user's face and thus ensures a good fit of the mask. The spring allows some movement of the bracing device 1 with respect to the helmet 3, for improved user comfort. It is contemplated that other types of elastic coupling (for example use of an elastomer) between the two pieces would serve a similar purpose.

The spring or other elastic material which provides this biasing may be mounted in any way to give the required coupling. In some embodiments, the spring may be directly connected to the first and second pieces 121, 122. To reduce the chance of fouling or damage to the spring, a covered or otherwise protected or concealed spring or elastomer etc. can be used.

To facilitate secure fitment of the mask, along with smooth adjustment of the fit, the first and second pieces 121, 122 of the connection portions 120 may be coupled by a sliding mechanism. For example, the first piece 121 may comprise a channel in which a lug on the second piece 122 can run, controlling the movement of the two with respect to one another and confining movement to a particular pathway. Or, two or more such channels and lugs could be provided, on either the first piece 121 or the second piece 122.

If such lugs and channels are used as the sliding mechanism, the spring or other elastic coupling of the pieces 121, 122 may be concealed inside one of the first and second piece, further reducing the chance of damage to it.

A further feature of the present invention can be seen from FIG. 10. As noted above, some helmets may include a protective visor 33, which in the illustrated example can be hinged at positions 34 to swing down in front of the user's face. Usually, these visors are of sufficient length to completely protect the user's face, and therefore the bracing device 10 is generally covered.

In these situations, the exhale valve of the respirator mask being worn is very close to the visor. When the user exhales through the valve, the warmth and moisture of the exhaled air may be sufficient to cause condensation to form on the visor 33, leading to a ‘fogging’. This can seriously impair visibility and the user's safety.

So, the pressure element 10 is adapted such that it partially obscures the exhale valve of the respirator mask (not shown), and ‘funnels’ exhaled air downwards and away from a deployed visor 33. This can greatly reduce the fogging effect.

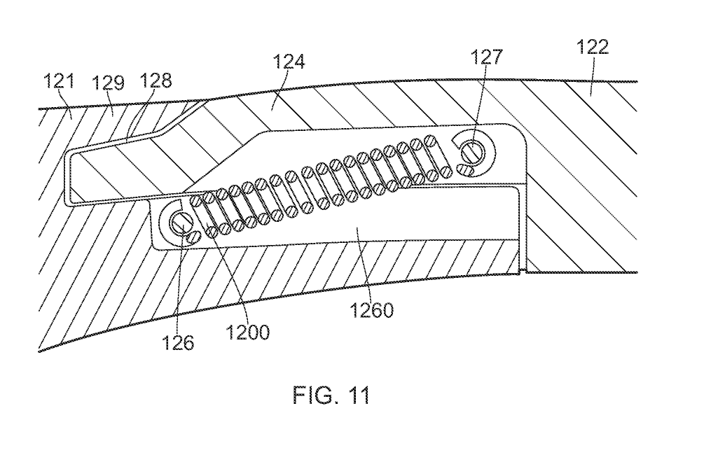

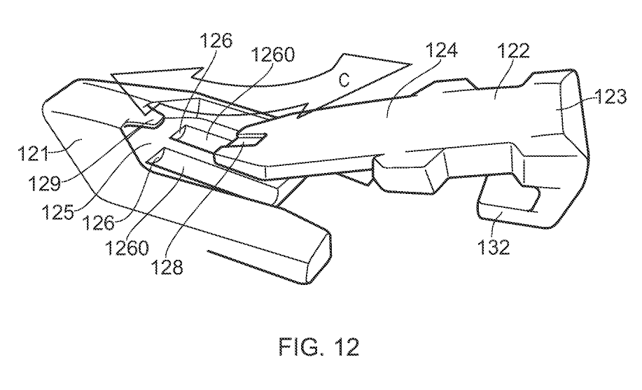

FIGS. 11 and 12 show a preferred mode of connection between the first and second pieces 121, 122 of the connection portions 120. As shown in FIG. 11, a helical spring 1200 is connected to the first piece 121 at a point 126, and to the second piece 122 at a point 127. FIG. 11 shows the connection portion 120 fully distended. In the illustrated embodiment, the two points are not aligned, leaving the spring in a diagonal/non-parallel configuration compared with the connection portions. This angling of the spring means that, when the connection portion 120 is extended in the horizontal direction, the two pieces 121, 122 are urged together in two dimensions, corresponding to the horizontal and the vertical in FIG. 11. This ensures a good connection between the first and second pieces 121, 122.

A tongue 124 formed on the second piece 122 moves in a groove 125 (not visible in FIG. 11) in the first piece 121, keeping the first and second pieces 121, 122 aligned. A projection 129 overhangs the end of the groove 125, and a notch 128 in the end of the tongue 124 can fit under the projection 129 to provide a secure fit between the pieces when the spring is contracted This is shown more clearly in FIG. 12. Of course, the features of the first and second pieces 121, 122 could be reversed and the same principles still apply.

With no channel or lug connection between the pieces, the above described connection allows maximal flexibility of the joint, helping to absorb shock. Furthermore, the positioning of the spring 1200 and the tongue 124 and groove 125 connection mean that the pieces are biased into a secure fitment position. If the user dons the device quickly, slightly mis-mounting the second piece 122 to the helmet 3, the spring 1200 can “pull” the piece back into its correct alignment with the first piece 121.

The first and second pieces 121, 122 of this embodiment are shown in more detail in FIG. 12. The motion of the second piece 122 as controlled by the spring 125 (not shown in FIG. 12) is illustrated by the arrow marked C. The tongue 124 slides in the groove 125, constrained by the walls thereof. As can be seen, the pieces 121, 122 can flex with respect to one another without loss of the joint's integrity. The tongue 124 and groove 125 keep the motion of the second piece 122 limited to the direction marked by the arrow C. FIG. 12 also shows that two springs 1200 (not shown) can be fitted to respective points 126 on the first piece 121 to increase the stability of the joint. In FIG. 12, each spring is provided with a barrel-like indentation 1260 in which it can flex and move, reducing the spatial requirement of the joint. Similar indentations may be provided on the underside of the second piece 122 (not shown).

In the embodiment shown in FIG. 10, the bracing device 1 further comprises a support member 103 which joins the two connection portions 120 to each other. This support member is adapted to bear against the forehead of the user. When respirator masks having, for example, a visor or goggle portion are used, it is important that a good seal is achieved in the forehead region to prevent any harmful agents getting behind the visor or goggles. The support member 103 can bear against the forehead portion of such a mask to ensure the integrity of the seal. As shown in FIG. 10, the support member may include, for example, fitment projections 104 for keeping a good fit between the bracing device and the helmet worn by the user, or to provide a secondary attachment to the helmet.

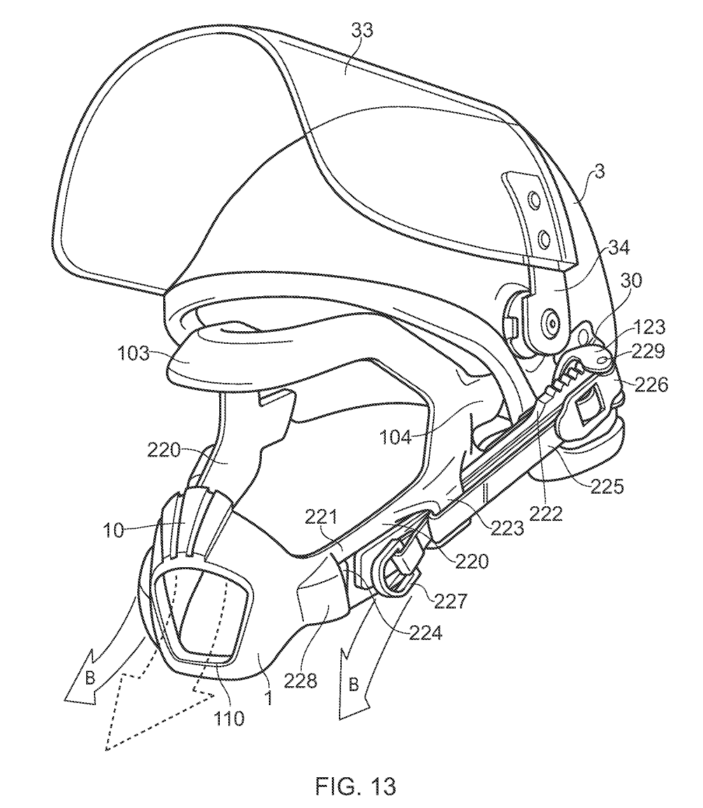

FIG. 13 shows a bracing device 1 according to a fourth embodiment of the present invention, partway through the process of attachment to a helmet 3. As with the third embodiment described above, the connection portions 220 are formed in two pieces: a first piece 221 connected to the pressure element 10, and a second piece 222 for attachment to the helmet 3. The second piece again comprises a helmet mounting portion 123 as previously described.

As in the third embodiment, in this fourth embodiment the first and second pieces 221, 222 are coupled together so that they are slideable with respect to one another. In the illustrated embodiment, the second piece 222 has the form of an arm, which is inserted through a slot 223 in the first piece 221 through which it can slide. The first piece 221 is shown with a shallow guide channel 224 cut therein to better guide the sliding path of the second piece 222 and thereby to prevent it interfering with the user. This guide path 224 also provides a smoother adjustment of the connection portion 220, as the arm in the guide channel 224 does not suffer from, for example, additional friction from interference with other parts of the bracing device 1. The guide channel 224 terminates in a ‘stop piece’ 228 which acts to stop the arm moving too far forward, or slipping out of the guide channel 224 when the arm is fully distended.

Again, as described above the two pieces 221, 222 are adjustably coupled to one another. This may be as in the third embodiment, using a spring or elastomer etc., but in the illustrated fourth embodiment a different arrangement is shown. A flexible strap 225 is attached to the first piece 221 (in FIG. 13, by looping around the upper part of the slot 223) and runs to a buckle 226 on the second piece 222. The illustrated fourth embodiment, as with the first and second embodiments described above, uses a “ladder-lock” type buckle for secure fastening. After the strap 225 has run through the buckle, it runs back, in this embodiment through the slot 223, and preferably terminates with a tag 227 for easy gripping and adjustment of the strap 225. The strap 225 may itself be elasticated in preferred embodiments.

To don a bracing device of this fourth embodiment, the user fits the device over their mask as with other embodiments described above. The second pieces 222 of the connection portions 220 are then slid through the slots 223, extending the strap lengths between the buckles 226 and the slots 223, against the bias of any elastication in the straps 225, and hooked into the helmet 3 at attachment slots 30.

When the bracing device 1 is fitted to the helmet 3 any elastication in the straps 225 pulls the two pieces 221, 222 together to provide a close fit to the user's face. If such fit is not tight enough for the user's preference, or if, for example, conditions change requiring modification of the fit, the strap 225 can be pulled, by the user pulling tag 227, through the buckle 226, tightening the fit of the mask. This is symbolised by the arrows marked “B” in FIG. 13.

In some circumstances, the user may wish to remove the fitted bracing device 1 quickly. In embodiments with straps 225 for adjusting the fit of the device 1, where the user has altered the fit of the device 1 by tightening the straps 225, the buckle 226 may cause difficulties to a quick loosening of the straps 225. If the user must inch the strap 225 through one aperture of the buckle 226, then move that slack through the other aperture, and then repeat the process until the straps 225 are loose enough for the mask to be removed, it may take an excessive time to remove the mask. Furthermore, the intricate movements required for this slow process may not be easy or even possible if the user is wearing, for example, protective gloves. To overcome this problem, the “ladder-lock” buckle 226 of the illustrated fourth embodiment is attached by a hinge 229 to the second piece 222 of the connection portion 220. When quick release is desired, the buckle 226 can be hinged ‘upward’, away from the second piece 222 of the connection portion 220, allowing the strap 225 to follow a much less frictionally resisted path through the buckle 226. Combined with the tension under which the straps 225 will be in such situations, hinging the buckle 226 up in this way acts as a “quick release” for the bracing device 1. As soon as the buckle 226 is hinged up, the tension in the strap 225 can act to pull it through its now freer path through the buckle 226 and thereby loosen the connection between the first piece 221 and second piece 222 of the connection portion 220, allowing easier removal of the bracing device 1 from the helmet 3.

The fourth embodiment illustrated in FIG. 13 also has a support member 103 as described above with respect to the third embodiment. The pressure element 10 is similarly adapted to that in the third embodiment, to divert air in a downward path by slight overlapping with the exhale valve.

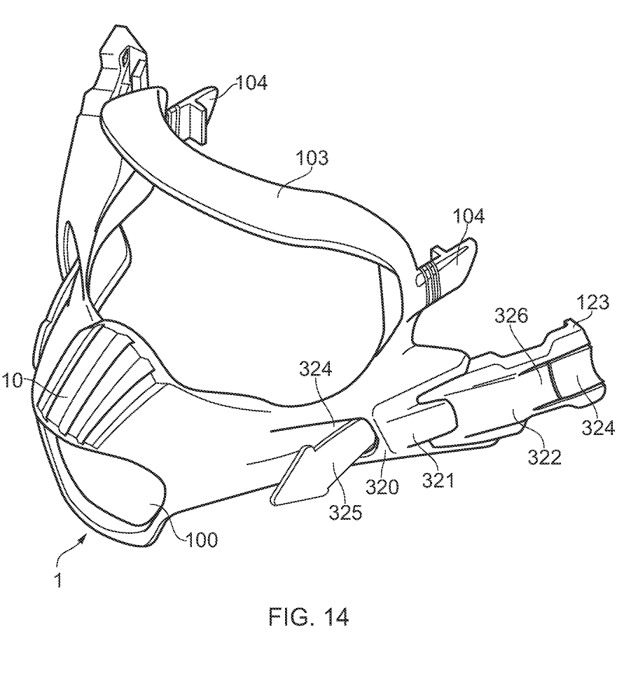

FIG. 14 shows a bracing device 1 according to a fifth embodiment of the present invention. Similarly to other embodiments previously described, the connection portions 320 are formed in two pieces: a first piece 321 connected to the pressure element 10, and a second piece 322 for attachment to the helmet 3 (not shown). The second piece comprises a helmet mounting portion 123 as previously described.

The fifth embodiment illustrated in FIG. 14 also has a support member 103 as described above with respect to the third and fourth embodiments. The pressure element 10 is similarly adapted to that in the third and fourth embodiments, to divert air in a downward path by slight overlapping with the exhale valve.

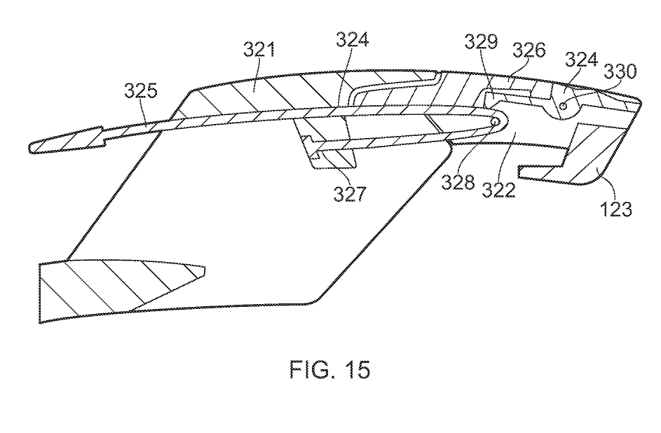

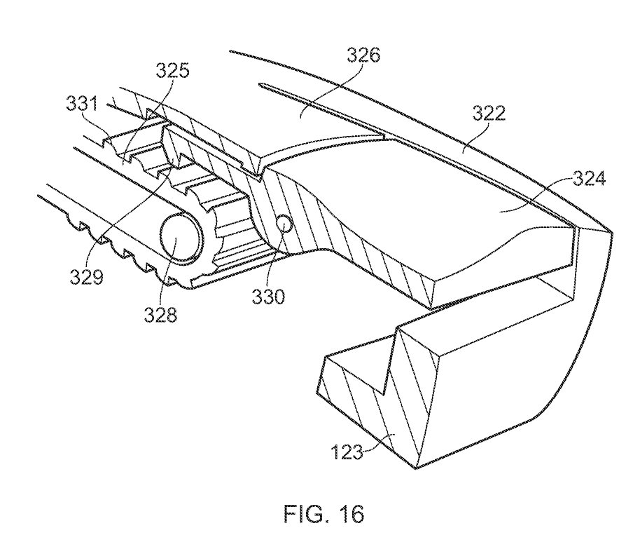

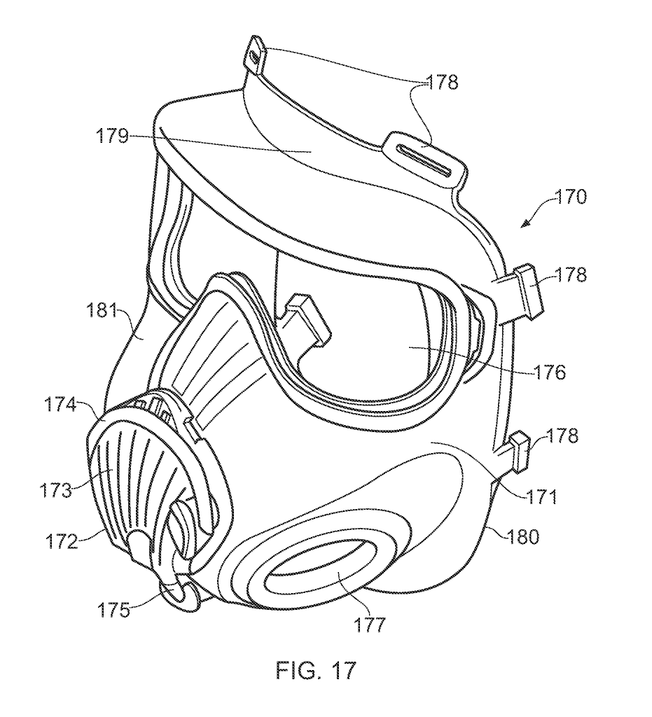

The first and second pieces 321, 322 of the connection portion 320 are coupled so as to be slideable with respect to one another. The formation of the first and second pieces 321, 322 is shown in more detail in FIGS. 15 and 16.

In this embodiment, the second piece 322 is connected to the first piece 321 by a strap 325 which is anchored in the first piece (not shown), and runs through a loop in the second piece 322 (not shown). It then runs through a path 324 in the first piece, becoming exposed at its end for the user to adjust.

In FIG. 14, the second piece 322 is shown in contact with the first piece 321, but elasticity in the strap 325 allows the two to be moved apart, connected only by the strap 325.

In this embodiment, the strap 325 is toothed (not shown in FIG. 14). The underside of the second piece 322 has a pawl projection corresponding to this toothing, such that the combination forms a ratchet system—this can be seen in FIG. 16. As the strap 325 is pulled through the path 324 in the first piece 321, the pawl projection on the underside of the second piece 322 ratchets over the teeth on the surface of the strap 325. This allows the strap 325 to move freely in one direction. Movement in the opposite direction is prohibited by the shape of the teeth on the strap 325 and the shape of the pawl projection on the underside of the second piece 322. Of course, the two could be reversed, the pawl projection being positioned on the first piece 321.

The pawl projection on the underside of the second piece 322 is controlled by way of a simple lever 324. When the button end of the lever 324 is pressed the pawl projection lifts from the strap 325, allowing free movement of the strap in both directions. When the button end of the lever 324 is released, resilience in a cantilever member 326 formed to oppose the lever 324 forces the pawl projection back into contact with the strap 325, renewing the ratchet hold thereon.

FIG. 15 shows the connection between the first piece 321 and the second piece 322 in cross sectional detail. As can be seen in this figure, the strap 325 is anchored to the first piece 321 at a point 327. In this instance, the anchoring is achieved simply by providing a shouldering to the end of the strap 325, which cannot fit through the anchor slot in the first piece 321. The strap 325 then runs to the second piece 322, looping around a mounting point 328 and proceeding through the path 324 in the first piece 321. The pawl projection 329 can interfere with teeth (not shown) on the strap 325 as it passes, to provide secure ratchet fitment as described above.

The lever 324 hinges around a point 330, meaning a user can press the button end of the lever 324 to raise the pawl projection 329. In doing so, the cantilever member 326 is forced away from the strap. When the user releases the lever 324 the cantilever member 326 returns to its original position, forcing the pawl projection 329 back onto the toothed strap 325.

The ratchet-like interaction between the strap 325 and the pawl projection 329 is shown in more detail in FIG. 16. It is noted that both ‘directions’ of ratchet are possible—the ‘smooth’ side of the pawl projection 329 can face either direction (contrast FIGS. 15 and 16), and the teeth 331 of the strap 325 must simply face the other direction for the ratchet connection to be effective.

To fit the device of the fifth embodiment, the second piece 322 can then be stretched or pulled away from the first piece 321 (with the lever 324 depressed to relieve the ratchet connection to the strap 325 if necessary) and fitted to the helmet (not shown) by way of the helmet mounting portion 123. Then, with the lever 324 released, the user can pull the strap 325 through the path 324, ratcheting the teeth 331 past the pawl projection 329 until the mask it suitable fixed. Elasticity in the strap 325 can allow for a more comfortable fit for the user, as in other embodiments described herein.

What is claimed is:

1. A respirator assembly to bear against the face of a user wearing a helmet, comprising:
a respirator mask having a frontpiece; and
a bracing device, comprising:
a pressure element mounted over the frontpiece of the respirator mask, for bearing against the frontpiece of the respirator mask to hold the respirator mask against the face of a user; and
two connection portions, each having a first end attached to the pressure element and a second end opposite the first end for attaching the bracing device to a helmet worn by a user, the connection portions being extendable;
the bracing device being separable from the respirator mask.

2. An assembly according to claim 1, wherein the first ends of the connection portions are attached to the pressure element at positions proximal the frontpiece of the mask.

3. An assembly according to claim 1, wherein the frontpiece of the respirator mask includes an exhale valve, and wherein the pressure element of the bracing device has an aperture therein through which the exhale valve protrudes.

4. An assembly according to claim 3, to bear against the face of a user wearing a helmet with a visor, the pressure element of the bracing device being adapted to overlap the exhale valve of the respirator mask such that air exhaled through the exhale valve is channelled away from the visor of the helmet.

5. An assembly according to claim 1, wherein at least one of the connection portions is formed in at least two pieces,
a first piece comprising the first end of the connection portion and being attached to the pressure element;
a second piece comprising the second end of the connection portion and being for attaching the bracing device to a helmet worn by the user;
the second piece being connected to the first piece such that it is movable with respect thereto, thereby extending or distending the connection portion.

6. An assembly according to claim 5, wherein the connection between the second piece and the first piece provides resistive load with extension.

7. An assembly according to claim 5, wherein the first piece is connected to the second piece by a strap, the strap being anchored at an anchor point on one of the first or the second piece;
the other of the first and second piece having a pawl projection thereon, and defining a path past the pawl projection through which the strap runs such that the pawl projection is engageable with the strap to limit movement of that strap through the path,
the pawl projection being movable from a first position in which it is engaged with the strap to a second position in which it is disengaged from the strap.

8. An assembly according to claim 7, wherein the piece having the pawl projection comprises a lever pivotable around a fixed fulcrum mounted on that piece; the portion of the lever on one side of the fulcrum comprising the pawl projection;
the lever having a first position in which the pawl projection is engaged with the strap and a second position in which the pawl projection is disengaged from the strap.

9. An assembly according to claim 8, wherein the lever is biased toward the first position.

10. An assembly according to claim 9, wherein the lever is biased by a resilient cantilever member mounted on the piece comprising the lever such that the cantilever member is deflected from its rest position when the lever is in the second position.

11. An assembly according to claim 7, wherein the path is substantially U shaped, running from an anchor point on one of the first and second piece to the other of the first and second piece, past the pawl projection on that piece, and through the piece which comprises the anchor point.

12. An assembly according to claim 7, wherein the strap is anchored to the first piece, the second piece having the pawl projection thereon.

13. An assembly according to claim 7, wherein the strap is toothed, the pawl projection being adapted to interlock with said teeth.

14. An assembly according to claim 5, wherein one of the first piece and the second piece has a groove therein and the other of the first piece and the second piece comprises a tongue corresponding to the groove, the tongue being mountable in the groove so as to be slideable therein.

15. An assembly according to claim 14, wherein the first piece and the second piece are connected by an elastic connection portion secured to the first piece at a first point positioned substantially at one side of the tongue, and connected to the second piece at a second point positioned substantially at the base of the groove.

16. An assembly according to claim 1, wherein the connection portions comprise flexible straps.

17. An assembly according to claim 1, wherein the respirator mask further comprises a forehead portion for fitment against a user's forehead, and wherein the bracing device further comprises a support member attached to each connection portion and extending between the connection portions, for bearing against the forehead portion of the respirator mask to hold that portion against the forehead of a user.

18. A mask bracing device for bearing against a respirator mask with a frontpiece worn by a user wearing a helmet, comprising:
a pressure element mountable over the frontpiece of a respirator mask, for bearing against the frontpiece of the respirator mask to hold the respirator mask against the face of a user; and
two connection portions each having a first end attached to the pressure element and a second end opposite the first end for attaching the bracing device to a helmet worn by a user, each formed in two pieces, the first piece comprising the first end of the connection portion and being attached to the pressure element; and the second piece comprising the second end of the connection portion and being for attaching the bracing device to a helmet worn by the user;
the first piece being connected to the second piece by a strap, the strap being anchored at anchor point on one of the first or the second piece;
the other of the first and second piece having a pawl projection thereon, and being defining a path past the pawl projection through which the strap runs such that the pawl projection is engageable with the strap to limit movement of that strap through the path,
the pawl projection being movable from a first position in which it is engaged with the strap to a second position in which it is disengaged from the strap.
